SEQUENCE LISTING (2 sequences)

SEQ ID NO: 1 - DNA, 20 bp, synthetic construct
  source 1..20: mol_type = other DNA
gcyggtgcwaacccngttgg

SEQ ID NO: 2 - DNA, 20 bp, synthetic construct
  source 1..20: mol_type = other DNA
aangtnccvcgvatcttgtt

(19) United States
(12) Patent Application Publication
(10) Pub. No.: US 2026/0262694 A1
(43) Pub. Date: Sep. 10, 2026

(54) LACTIPLANTIBACILLUS PLANTARUM STRAIN FMBL L23251 FJX AND ITS USE IN THE PREPARATION OF PRODUCTS FOR REDUCING BEANY FLAVOR

(71) Applicant: SHIHEZI UNIVERSITY, Shihezi City (CN)

(72) Inventors: Hailong SUN, Shihezi City (CN); Yongqing NI, Shihezi City (CN); Sainaiwaer AIHETANMU, Shihezi City (CN); Yuxin CHU, Shihezi City (CN); Lili HUANG, Shihezi City (CN); Xiaojing WEI, Shihezi City (CN)

(21) Appl. No.: 19/533,164

(22) Filed: Feb. 7, 2026

(30) Foreign Application Priority Data
Mar. 5, 2025 (CN) 2025102542120
Mar. 5, 2025 (CN) 2025102546526

(51) Int. Cl. A23L 33/135; A23C 9/123; A23C 9/137; A23L 11/50

(52) U.S. Cl. CPC A23L 33/135; A23C 9/123; A23C 9/1234; A23C 9/137; A23L 11/50; A23V 2200/3204

(57) ABSTRACT

The present disclosure belongs to the field of biotechnology, and specifically relates to a Lactiplantibacillus plantarum strain FMBL L23251 FJX and uses of the strain. The Lactiplantibacillus plantarum strain FMBL L23251 FJX was deposited with the China Center for Type Culture Collection (CCTCC) on Jun. 26, 2023, under the accession number CCTCC NO: M 20231100. The strain possesses properties including antioxidant activity, acid tolerance, sensitivity to antibiotics, and substantial antibacterial activity. Fermentation of chickpeas using the strain demonstrates antioxidant capacity and dipeptidyl peptidase IV (DPP-IV) inhibitory activity, produces short-chain fatty acids and B vitamins, and reduces the beany flavor in legume products. The strain, when combined with chickpea powder to prepare chickpea yogurt, promotes the release of volatile flavor compounds. The Lactiplantibacillus plantarum strain FMBL L23251 FJX has broad application prospects.

### CROSS-REFERENCE TO RELATED APPLICATIONS

This application claims priority to Chinese Patent Application No. 202510254212.0, filed on Mar. 5, 2025, and Chinese Patent Application No. 202510254652.6, filed on Mar. 5, 2025, the content of which are incorporated herein by reference in its entirety.

### REFERENCE TO SEQUENCE LISTING

This application contains a Sequence Listing which has been submitted in XML format via EFS-Web and is hereby incorporated by reference in its entirety. Said XML copy is named “Lactiplantibacillus plantarum Strain FMBL L23251 FJX and Its Use in the Preparation of Products for Reducing Beany Flavor TECHNICAL FIELD.xml”, created Feb. 2, 2026, and has a size of 3,048 bytes.

### TECHNICAL FIELD

The present disclosure belongs to the field of biotechnology, and specifically relates to a Lactiplantibacillus plantarum strain FMBL L23251 FJX and its use in the preparation of products for reducing beany flavor.

### BACKGROUND

With economic development, people's pursuit of food is no longer merely about satisfying satiety but rather about the direct benefits to personal health. Emerging dairy products incorporate specific probiotics to enhance human health, emphasizing additional health benefits beyond those of traditional dairy products. In 2020, the Probiotics Branch of the Chinese Institute of Food Science and Technology issued the “Scientific Consensus on Probiotics (2020 Edition)”, outlining three core characteristics of probiotics: sufficient quantity, viable state, and beneficial health function. However, achieving the target viability of probiotics in fermented milk is not easy. Unlike traditional starters, most probiotics cannot utilize lactose and lack the ability to hydrolyze casein, consequently exhibiting poor growth capability in cow's milk. Furthermore, these probiotics exhibit poor acid-producing capacity and low fermentation rate, making them unsuitable for use as starters. Therefore, adding probiotics that meet the requirements into dairy products has become a technical problem urgently needing resolution by those skilled in the art.

Beany flavor affects the taste and flavor of legume products, making some consumers find them difficult to accept. For example, common legume products such as soy milk and tofu, if possessing a strong beany flavor, can mask their inherent bean aroma and mellow taste, reducing product quality and market acceptance. Methods for removing beany flavor include heat treatment, soaking treatment, additive addition, and the like. Among these, heat treatment methods such as boiling, steaming, or frying are commonly used to inactivate lipoxygenase, thereby inhibiting the enzyme-catalyzed oxidation reaction and reducing the production of beany flavor substances. However, heat treatment can cause loss of nutrients. Soaking treatment can remove part of the beany flavor, but improper control of soaking time can lead to microbial growth, affecting quality. Adding cyclic oligosaccharides such as β-cyclodextrin can encapsulate beany flavor substances through molecular inclusion, thereby reducing their volatility and mitigating the beany flavor. Additionally, adding certain spices, sweeteners, etc., can adjust the product's flavor and mask the beany flavor, but restricted use of additives limits their application. How to remove the beany flavor without affecting the quality of legume products and without loss of nutritional value has become a technical problem urgently needing resolution by those skilled in the art. Chickpeas are rich in bioactive substances such as galacto-oligosaccharides, unsaturated fatty acids, vitamins, and isoflavones, as well as trace elements like iron, zinc, magnesium, calcium, and selenium. Chickpeas also contain volatile aldehydes such as hexanal and benzaldehyde, alcohols such as 1-hexanol, ketones such as 2-heptanone, and substances like acetone. These compounds cause chickpeas to produce significant beany flavor and pungent odors during processing, increasing the complexity of the beany flavor and reducing consumer purchase desire for chickpeas.

The inventor's research group has long been dedicated to the study of probiotics and has screened and obtained multiple bacterial strains with specific functions from human feces. For example, Lactiplantibacillus plantarum FMBL L23252 FJX can efficiently utilize chickpea extract to achieve rapid proliferation. After fermenting in chickpea extract for 12 hours, the viable cell count of Lactiplantibacillus plantarum FMBL L23252 FJX can reach 9.23+0.02 log 10 (colony-forming units (CFU)/mL). After 21 days of storage at 4° C., the viable cell count in the chickpea extract can still remain above 7.49±0.01 log 10 (CFU/mL). The viable cell count is sufficient and maintains a viable state, allowing Lactiplantibacillus plantarum FMBL L23252 FJX to be used for fermenting dairy products.

Based on the aforementioned technical solution, the inventor's research group conducted continuous research and screened and obtained a Lactiplantibacillus plantarum strain FMBL L23251 FJX. Compared with Lactiplantibacillus plantarum FMBL L23252 FJX, the Lactiplantibacillus plantarum strain FMBL L23251 FJX possesses properties including antioxidant activity, acid tolerance, sensitivity to antibiotics, and substantial antibacterial activity. Using the Lactiplantibacillus plantarum strain FMBL L23251 FJX combined with a prebiotic to prepare yogurt results in a yogurt with a high viable cell count during storage, significantly increased yogurt acidity and sensory scores, richer and more robust taste, high content of volatile flavor compounds, and broad application prospects.

### SUMMARY

The primary objective of the present disclosure is to provide a Lactiplantibacillus plantarum strain FMBL L23251 FJX, deposited with the China Center for Type Culture Collection (CCTCC) under the accession number CCTCC NO: M 20231100.

Preferably, the strain is for use in the preparation of a bacterial agent or a fermentation broth.

Preferably, the bacterial agent or the fermentation broth has antioxidant, acid-tolerant, and/or antibacterial properties.

The present disclosure also provides a use of the strain in the manufacture of a food or a dietary supplement.

Preferably, the food or the dietary supplement is yogurt or prebiotic yogurt.

Preferably, the food or the dietary supplement is a legume product.

Preferably, the legume product is prepared by fermenting a legume, wherein the legume is selected from the group consisting of chickpea, soybean, broad bean, pea, mung bean, mixed bean, pigeon pea, and sword bean, and combinations thereof.

Preferably, the legume product is fermented bean milk or fermented bean yogurt.

Preferably, the fermented bean milk or the fermented bean yogurt has reduced beany flavor.

Preferably, the fermented chickpea yogurt has increased short-chain fatty acid content.

Preferably, the fermented chickpea yogurt is capable of inhibiting dipeptidyl peptidase IV activity.

Preferably, the fermented chickpea yogurt has a blood sugar-lowering effect.

Preferably, the fermented bean yogurt is fermented chickpea yogurt.

The present disclosure also provides a method of reducing beany flavor in a legume product, including using the legume product as a substrate and fermenting the substrate with the strain.

The present disclosure also provides a fermented bean milk having reduced beany flavor, wherein the fermented bean milk is produced by the method.

The beneficial effects of the present disclosure are as follows: the present disclosure provides a Lactiplantibacillus plantarum strain FMBL L23251 FJX. The Lactiplantibacillus plantarum strain FMBL L23251 FJX was deposited with the CCTCC on Jun. 26, 2023, under the accession number CCTCC NO: M 20231100. The Lactiplantibacillus plantarum strain FMBL L23251 FJX possesses properties including antioxidant activity, acid tolerance, sensitivity to antibiotics, and substantial antibacterial activity. Fermentation of chickpeas using the strain demonstrates DPPH radical scavenging capacity, ABTS radical scavenging capacity, and dipeptidyl peptidase IV (DPP-IV) inhibitory activity, produces short-chain fatty acids and B vitamins, and significantly reduces the beany flavor in legume products. Combining the strain with chickpea powder to prepare chickpea yogurt, while ensuring the viable cell count during storage, further enhances the antioxidant capacity of the yogurt and also promotes the release of volatile flavor compounds. The Lactiplantibacillus plantarum strain FMBL L23251 FJX has broad application prospects.

### BRIEF DESCRIPTION OF THE DRAWINGS

FIG. 1 shows a phylogenetic tree of the Lactiplantibacillus plantarum strain FMBL L23251 FJX.

FIG. 2 shows the antioxidant activity of fermented chickpea milk.

FIG. 3 shows the pH value, acidity, and sensory scores of fermented milk with different chickpea concentrations.

FIG. 4 shows the antioxidant capacity of chickpea yogurt.

FIG. 5 shows the volatile flavor compounds of chickpea yogurt.

FIG. 6 shows changes in the viable cell count of Lactiplantibacillus plantarum FMBL L23251 FJX during the storage period.

### DETAILED DESCRIPTION OF THE EMBODIMENTS

The protection scope of the present disclosure is described in detail below with reference to specific embodiments. It should be noted that the protection scope of the present disclosure is not limited by the following embodiments.

The formulations of the culture media used are as follows:

MRS Liquid Medium: Peptone 10 g; Beef extract 10 g; Yeast extract 5 g; Glucose 20 g; Tween 80 1 mL; K2HPO4 2 g; Sodium acetate 5 g; Diammonium hydrogen citrate 2 g; MgSO4·7H2O 0.58 g; MnSO4·4H2O 0.25 g; Deionized water 1000 mL.

LAMVAB Solid Medium (per 1 L): Peptone 10 g; Beef extract 8 g; Yeast extract 4 g; Glucose 20 g; Tween 80 1 mL; K2HPO4 2 g; Sodium acetate 5 g; Diammonium hydrogen citrate 2 g; MgSO4.7H2O 0.2 g; MnSO4·4H2O 0.05 g; Agar 20 g; L-Cysteine hydrochloride 0.5 g; Vancomycin hydrochloride 20 mg; sterilized at 115° C. for 20 minutes.

PYG Medium: Peptone 10.0 g; Yeast extract 5.0 g; Glucose 1.0 g; Agar 20.0 g; Deionized water 1000 mL.

Tryptic Soy Agar (TSA) Medium: Tryptone 15.0 g; Soytone (Soybean peptone) 5.0 g; Sodium chloride 5.0 g; Agar 15 g; Deionized water 1000 mL.

Nutrient Broth Agar Medium: Peptone 5.0 g; Beef extract 3.0 g; Sodium chloride 5.0 g; Agar 20.0 g; Deionized water 1000 mL.

Experimental results are expressed as mean±standard deviation. Analysis of variance was performed using Duncan's test, and a value of p<0.05 was considered statistically significant.

It should be noted that the following examples are based on experiments conducted with chickpeas. However, the Lactiplantibacillus plantarum strain FMBL L23251 FJX described in the present disclosure can be used to ferment other legumes possessing a beany flavor through the same mechanism of action, resulting in legume products with significantly reduced beany flavor.

In the following embodiments, unless otherwise specified, the methods are conventional methods obtainable from the literature, and the reagents are commercially available.

### Embodiment 1: Strain Isolation and Identification

### 1. Strain Isolation and Purification

Strains were isolated from fecal samples of the Han Chinese population in the Wuwei region according to conventional methods. Collected fresh children's feces were placed in sampling tubes. One gram of the fecal sample was inoculated into 9 mL of MRS liquid medium, thoroughly mixed, and diluted to 10-3, 10-4, and 10-5. The diluted samples were spread onto LAMVAB agar medium and cultured under anaerobic conditions at 37° C. for 24-48 hours. Suspected lactic acid bacterial colonies were picked and purified three times. The isolates were preserved in MRS liquid medium supplemented with 25% glycerol and stored in an ultra-low temperature freezer at −80° C.

### 2. Strain Identification

Genomic DNA of the strain was extracted using a Bacterial Genomic DNA Rapid Extraction Kit. Polymerase chain reaction (PCR) amplification of the strain's groEL gene was performed using species-specific primers, as shown in Table 1. After the reaction, the PCR products were detected by agarose gel electrophoresis. Products passing the quality check were sent for sequencing to GENEWIZ (Suzhou) Inc. The obtained strain sequence was submitted to the NCBI database for BLAST comparison. Homologous species sequences of the strain were downloaded, and a phylogenetic tree was constructed using the Neighbor-Joining method with software MEGA version 11.0.

TABLE 1
PCR Amplification of the groEL Gene

| PCR | |
|---|---|
| Amplification | Conditions |
| Template | Genomic DNA |
| Primers | Lac-groEL-F (SEQ ID NO. 1): |
| | 5′-GCYGGTGCWAACCCNGTTGG-3′ |
| | Lac-groEL-R (SEQ ID NO. 2): |
| | 5′-AANGTNCCVCGVATCTTGTT-3′ |
| Reaction | Pre-denaturation at 95° C. for 10 min; 34 cycles of denaturation |
| Conditions | at 95° C. for 30 s, annealing at 54° C. for 30 s, and extension at |
| | 72º C. for 40 s; final extension at 72° C. for 5 min. |

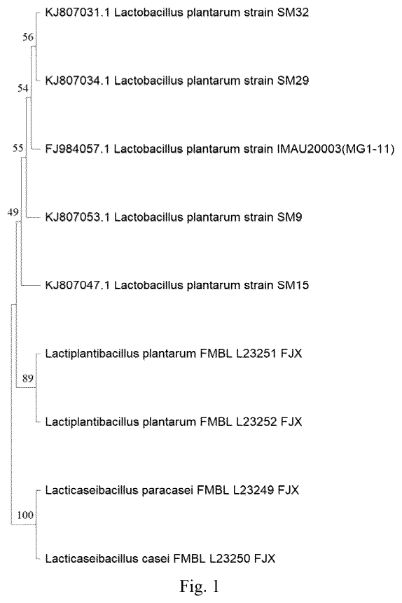

The phylogenetic tree of the strain FMBL L23251 FJX is shown in FIG. 1. Upon identification, the obtained strain was confirmed to be Lactiplantibacillus plantarum (scientific name). The strain was designated as Lactiplantibacillus plantarum FMBL L23251 FJX. The strain was deposited with the CCTCC on Jun. 26, 2023, under the accession number CCTCC NO: M 20231100. The depository address is: Wuhan University, Wuhan, China. Telephone: 027-68754052.

In the following embodiments, the strain is abbreviated as Lactiplantibacillus plantarum FMBL L23251 FJX.

### Embodiment 2: Characterization of Lactiplantibacillus plantarum FMBL L23251 FJX

### 1. Experimental Strains

The strains involved include Lactiplantibacillus plantarum FMBL L23251 FJX, Lactiplantibacillus plantarum FMBL L23220 CLL, and Lactiplantibacillus plantarum FMBL L23252 FJX, all of which were screened and obtained by laboratory researchers. The information is as follows.

TABLE 2
Experimental Strain Information

| Strain Designation | Species | Accession Number |
|---|---|---|
| Lactiplantibacillus plantarum | Lactiplantibacillus | CCTCC NO: M |
| FMBL L23220 CLL | plantarum | 20232291 |
| Lactiplantibacillus plantarum | Lactiplantibacillus | CCTCC NO: M |
| FMBL L23251 FJX | plantarum | 20231100 |
| Lactiplantibacillus plantarum | Lactiplantibacillus | CCTCC NO: M |
| FMBL L23252 FJX | plantarum | 20231102 |
| Lactiplantibacillus plantarum | Lactiplantibacillus | CGMCC1.6971 |
| WCFS1 | plantarum | |

### 2. Determination of Antioxidant Properties

After activation, the strains were added to MRS liquid medium at an inoculum size of 2% (v/v), with an optical density at 600 nm (OD600) of 1.0±0.05, and anaerobically cultured at 37° C. for 24 hours. The cultures were then centrifuged at 10000 revolutions per minute (rpm) for 5 minutes. The supernatant was filtered through a 0.22 μm aqueous microfilter membrane to harvest the Cell-Free Supernatant (CFS). The bacterial cells were washed twice with Phosphate Buffered Saline (PBS) and then resuspended in PBS to prepare a bacterial suspension of 1×108 CFU/mL for subsequent use.

### (1) Determination of DPPH Scavenging Capacity

A 0.2 mM DPPH-methanol solution was prepared. The CFS or the bacterial suspension was thoroughly mixed with the 0.2 mM DPPH-methanol solution at a 1:1 ratio and reacted in the dark for 60 minutes. The OD value of the supernatant was measured at 517 nm. Three replicate experiments were set up.

$$DPPH scavenging activity ( \% ) = [ A 0 - ( Ai - Aj ) ] / A 0 * 100 \%$$

Where: D0: Absorbance value at 517 nm (OD517) of 1 mL PBS buffer. D1: Absorbance value at 517 nm (OD517) of 1 mL sample solution+1 mL DPPH-methanol solution. D2: Absorbance value of 1 mL sample solution+1 mL anhydrous methanol.

### (2) Determination of ABTS Scavenging Capacity

A 7 mmol/L ABTS working solution was prepared. Precisely 15 mL of a prepared 3.8 g/L ABTS solution (prepared with deionized water) was mixed with 0.264 mL of an aqueous potassium persulfate solution (molar concentration of 140 mmol/L). The mixture was allowed to stand at room temperature in the dark for 12-16 hours. Anhydrous ethanol was used to adjust the OD of the working solution to 0.7±0.02 at 734 nm. The test sample and the adjusted ABTS working solution were mixed at a 1:6 ratio and allowed to stand at room temperature for 30 minutes. The absorbance was measured at 734 nm. Three replicate experiments were set up.

$$ABTS scavenging activity ( \% ) = [ ( A 0 - A ) / A 0 ] * 100 \%$$

Where, A0: Absorbance value of an equal volume of water. A: Absorbance value of the sample solution.

The scavenging capacities of the strains against DPPH radicals and ABTS radicals are shown in Table 3. The CFS of Lactiplantibacillus plantarum FMBL L23220 CLL showed a DPPH radical scavenging rate of 29.11%; the bacterial suspension of Lactiplantibacillus plantarum FMBL L23220 CLL showed a DPPH radical scavenging rate of 33.87%. The CFS of Lactiplantibacillus plantarum FMBL L23251 FJX showed a DPPH radical scavenging rate of 8.13%, and the bacterial suspension of Lactiplantibacillus plantarum FMBL L23251 FJX showed a DPPH radical scavenging rate of 39.44%. The CFS of Lactiplantibacillus plantarum FMBL L23220 CLL showed an ABTS radical scavenging rate of 90.34%; the bacterial suspension of Lactiplantibacillus plantarum FMBL L23220 CLL showed an ABTS radical scavenging rate of 15.48%. The CFS of Lactiplantibacillus plantarum FMBL L23251 FJX showed an ABTS radical scavenging rate of 89.71%, and the bacterial suspension of Lactiplantibacillus plantarum FMBL L23251 FJX showed an ABTS radical scavenging rate of 41.49%. Significant differences were observed, indicating that Lactiplantibacillus plantarum FMBL L23251 FJX can produce antioxidant activity to reduce oxidative stress.

TABLE 3
Antioxidant Capacity of Lactiplantibacillus plantarum FMBL L23251 FJX

| | DPPH Radical | | ABTS Radical | |
|---|---|---|---|---|
| | Scavenging Rate (%) | | Scavenging Rate (%) | |
| | | Bacterial | | Bacterial |
| | CFS | Suspension | CFS | Suspension |
| Lactiplantibacillus | 29.11 ± 1.93^{a} | 33.87 ± 1.28^{a} | 90.34 ± 0.12 | 15.48 ± 0.12^{a} |
| plantarum FMBL L23220 | | | | |
| CLL | | | | |
| Lactiplantibacillus | 8.13 ± 0.32^{b} | 39.44 ± 0.66^{b} | 89.71 ± 0.05 | 41.49 ± 0.16^{b} |
| plantarum FMBL L23251 | | | | |
| FJX | | | | |

Note:
Different superscript letters indicate significant differences.

### 3. Determination of Acid Tolerance

After activation, the strains were added to MRS liquid medium at an inoculum size of 2% (v/v) (OD600: 1.0±0.05) and anaerobically cultured at 37° C. for 24 hours. The cultures were then centrifuged at 10000 rpm for 5 minutes, the supernatant was discarded, and the bacterial pellet was collected. The pellet was then resuspended in MRS liquid medium adjusted to different pH values (2.0, 2.5, 3.0, 3.5, 4.0). Samples were taken for spreading on agar plates at 0 hours and after 4 hours of incubation in an anaerobic chamber. Viable cell counts were performed after 48 hours of incubation to calculate the survival rate under different pH conditions.

TABLE 4
Determination of Strain Acid Tolerance

| | pH = | pH = | pH = | pH = | pH = |
|---|---|---|---|---|---|
| Strain | 2.0 | 2.5 | 3.0 | 3.5 | 4.0 |
| Lactiplantibacillus | 4.38% | 12.41% | 17.52%^{a} | 14.60%^{a} | 24.09% |
| plantarum | | | | | |
| FMBL L23220 CLL | | | | | |
| Lactiplantibacillus | 5.35% | 13.39% | 15.77%^{b} | 21.43%^{b} | 23.21% |
| plantarum | | | | | |
| FMBL L23251 FJX | | | | | |

The health-promoting effects of lactobacilli as probiotic supplements primarily depend on their ability to survive the highly acidic environment of the stomach and subsequently adhere to and colonize the gastrointestinal tract. The pH of human and animal gastric acid ranges from 1.5 to 3.0. Lactobacilli must possess a certain degree of acid tolerance to gastric acid to exert their probiotic effects in vivo. As can be seen from Table 4, both Lactiplantibacillus plantarum FMBL L23251 FJX and FMBL L23220 CLL were able to survive within the pH range of 2.0 to 4.0. Furthermore, the survival rate of Lactiplantibacillus plantarum FMBL L23251 FJX was significantly higher than that of FMBL L23220 CLL under the condition of pH 3.5. This indicates that Lactiplantibacillus plantarum FMBL L23251 FJX possesses good acid tolerance, enabling the strain to reach the colonization site, thereby surviving, growing, and exerting probiotic effects in the gastrointestinal tract.

### 4. Drug Susceptibility Test

The disk diffusion (Kirby-Bauer, K-B) method was employed. Information on the antibiotic disks is listed in Table 5. The strains were inoculated into medium at 2% inoculum size and cultured in an anaerobic chamber for 24 hours. The activated strains were diluted and spread onto agar plates (bacterial concentration at 107-108 CFU/mL). The antibiotic disks were placed on the solid medium and anaerobically cultured at 37° C. for 24 hours. The diameter of the inhibition zone around each disk was measured. The experiment was repeated three times.

TABLE 5
Antibiotic Disk Information

| Abbreviation | Name | Content |
|---|---|---|
| RD | Rifampin | 5 μg/disk |
| TE | Tetracycline | 30 μg/disk |
| MH | Minocycline | 30 μg/disk |
| CN | Gentamicin | 10 μg/disk |
| P | Penicillin G | 10 μg/disk |
| LEV | Levofloxacin | 5 μg/disk |
| S | Streptomycin | 300 μg/disk |
| AMP | Ampicillin | 10 μg/disk |
| CTX | Cefotaxime | 30 μg/disk |
| OX | Oxacillin | 1 μg/disk |
| C | Chloramphenicol | 30 μg/disk |
| FOX | Cefoxitin | 30 μg/disk |

To ensure the safety and reliability of edible probiotics for the human body, strain antibiotic resistance has become an important indicator for the in vitro safety assessment of probiotic strains. This experiment determined the susceptibility of the lactic acid bacteria to 12 antibiotics. The susceptibility of the strains to the antibiotic disks was determined based on the diameter of the inhibition zones. The experimental results were determined according to the CLSI data and susceptibility category criteria established by the Clinical and Laboratory Standards Institute (CLSI). The results are shown in Table 6 below. Lactiplantibacillus plantarum FMBL L23251 FJX was resistant to Gentamicin (CN), Streptomycin(S), Oxacillin (OX), and Cefoxitin (FOX).

TABLE 6
Drug Susceptibility Test Results

| Test Strain | RD | TE | MH | CN | P | LEV | S | AMP | CTX | OX | C | FOX |
|---|---|---|---|---|---|---|---|---|---|---|---|---|
| Lactiplantibacillus | S | R | S | R | I | R | S | S | S | R | S | I |
| plantarum | | | | | | | | | | | | |
| FMBL L23220 | | | | | | | | | | | | |
| CLL | | | | | | | | | | | | |
| Lactiplantibacillus | S | S | S | R | S | S | R | S | S | R | S | R |
| plantarum | | | | | | | | | | | | |
| FMBL L23251 | | | | | | | | | | | | |
| FJX | | | | | | | | | | | | |

Note:
R: Resistant; I: Intermediate; S: Susceptible.

### 5. Antibacterial Experiment

The Oxford cup method was employed. Using the strains listed in Table 7 as indicator bacteria, the Oxford cup method was used to determine the antibacterial activity of the strains against different indicator bacteria. The strains were inoculated into MRS liquid medium at a 2% inoculum size and cultured at 37° C. for 24 hours. After two consecutive subcultures, the fermentation broth was centrifuged at 8000 rpm for 10 minutes. The supernatant was filtered through a 0.22 μm filter membrane to obtain the Cell-Free Fermentation Supernatant (CFS). The indicator bacteria were diluted to a certain concentration and spread onto agar plates. Sterile Oxford cups were placed on the plates spread with the indicator bacteria. Then, 0.2 mL of the CFS was added into the Oxford cups. After diffusion at 4° C. for 4 hours, the plates were placed in an incubator and cultured for 24 hours. The diameter of the inhibition zone was measured.

TABLE 7
Source of Indicator Bacteria

| | | | Accession | |
|---|---|---|---|---|
| Code | Strain | Source | Number | Medium |
| 10411 | Enteropathogenic | China Center of | CICC 10411 | Nutrient |
| | Escherichia coli | Industrial Culture | | Agar |
| | (EPEC O127:K63) | Collection | | |
| | | (CICC) | | |
| 10421 | Enterotoxigenic | China Center of | CICC 10421 | Nutrient |
| | Escherichia coli | Industrial Culture | | Agar |
| | (ETEC O78:K80) | Collection | | |
| | | (CICC) | | |
| 10420 | Salmonella enterica | China Center of | CICC 10420 | Nutrient |
| | subsp. enterica | Industrial Culture | | Agar |
| | serovar | Collection | | |
| | Typhimurium | (CICC) | | |
| 21530 | Enterohemorrhagic | China Center of | CICC 21530 | Nutrient |
| | Escherichia coli | Industrial Culture | | Agar |
| | (EHEC O157:H7) | Collection | | |
| | | (CICC) | | |
| SM1 | Salmonella enterica | China General | CGMCC | TSA |
| | subsp. enterica | Microbiological | 1.10⁷54 | Medium |
| | | Culture | | |
| | | Collection Center | | |
| | | (CGMCC) | | |
| LS1 | Listeria | China General | CGMCC | PYG |
| | monocytogenes | Microbiological | 1.9136 | Medium |
| | | Culture | | |
| | | Collection Center | | |
| | | (CGMCC) | | |

The Oxford cup method was used to determine the antibacterial effects of the two strains against six common pathogenic bacteria. The results are shown in Table 8. Lactiplantibacillus plantarum FMBL L23251 FJX exhibited substantial antibacterial activity against Enteropathogenic Escherichia coli (10411), Enterohemorrhagic Escherichia coli (21530), Salmonella enterica subsp. enterica serovar Typhimurium (10420), Listeria monocytogenes (LS1), and Salmonella enterica subsp. enterica serovar Enteritidis (SM1). Furthermore, the antibacterial activity of Lactiplantibacillus plantarum FMBL L23251 FJX against Salmonella enterica subsp. enterica (SM1) and Listeria monocytogenes (LS1) was significantly higher than that of Lactiplantibacillus plantarum FMBL L23220 CLL.

TABLE 8
Determination of Strain Antibacterial Activity

| Test Strain | 10411 | 10421 | 21530 | 10420 | LS1 | SM1 |
|---|---|---|---|---|---|---|
| Lactiplantibacillus | ++ | − | ++ | +++ | − | + |
| plantarum | | | | | | |
| FMBL L23220 CLL | | | | | | |
| Lactiplantibacillus | ++ | − | + | ++ | + | ++ |
| plantarum | | | | | | |
| FMBL L23251 FJX | | | | | | |

Note:
Inhibition zone diameter ≤ 15 mm: +; 15 mm < Inhibition zone diameter ≤ 20 mm: ++; 20 mm < Inhibition zone diameter ≤ 25 mm: +++; 25 mm < Inhibition zone diameter: ++++; No inhibition zone: −.

### 6. Surface Hydrophobicity and Auto-Aggregation

### (1) Surface Hydrophobicity

Xylene was selected as the hydrophobic organic solvent to detect the surface hydrophobicity of the lactobacilli. The strains were inoculated into medium and cultured in an anaerobic chamber for 24 hours. The bacterial cells were collected by centrifugation, washed twice, and resuspended in PBS buffer to adjust the OD600 to 0.6±0.05 (A0). The bacterial suspension and xylene were mixed at a ratio of 3:1. The mixture was allowed to stand for 10 minutes, then vortexed for 2 minutes, and subsequently left to stand and incubate for 30 minutes. The aqueous phase of the mixture was taken, and its absorbance at OD600 was measured (A1). Three parallel experiments were set up.

$$Surface hydrophobicity ( H \% ) = ( 1 - A 1 / A 0 ) \times 100 \%$$

Where, A1 is the absorbance value of the aqueous phase in the mixture at OD600; A0 is the OD600 value of the bacterial suspension.

### (2) Auto-Aggregation Assay

The bacterial cells were cultured in MRS liquid medium for 24 hours. The bacterial cells were collected by centrifugation, washed twice, and resuspended in PBS buffer to adjust the OD600 to 0.6±0.05 (A0). The bacterial suspension was vortexed for approximately 5 minutes. The suspension was then placed at 37° C., and the absorbance at OD600 was measured after 2 hours, 4 hours, and 6 hours, respectively (A2). Three parallel experiments were set up.

$$Auto - aggregation capacity ( A \% ) = ( 1 - A 2 / A 0 ) \times 100 \%$$

Where, A2 is the absorbance value of the bacterial suspension at 2 h, 4 h, and 6 h; A0 is the OD600 value of the bacterial suspension in PBS buffer.

Bacterial surface hydrophobicity mainly refers to the unstable state of bacteria in polar water, which causes changes in the redistribution and arrangement of the bacterial cells. Auto-aggregation occurs during the massive and rapid proliferation of bacterial cells. The auto-aggregation and hydrophobicity of bacteria are closely related to their adhesiveness. Strains with good adhesive capacity can inhibit the invasion of pathogenic bacteria. The results of the surface hydrophobicity and auto-aggregation of the strains are shown in Table 9. The surface hydrophobicity and auto-aggregation of Lactiplantibacillus plantarum FMBL L23251 FJX were significantly superior to those of Lactiplantibacillus plantarum FMBL L23220 CLL.

TABLE 9
Strain Surface Hydrophobicity and Auto-aggregation

| Test | Hydrophobicity | Auto-aggregation (%) | | |
|---|---|---|---|---|
| Strain | (%) | 2 h | 4 h | 6 h |
| FMBL | 4.21 ± 0.25^{a} | 0.45 ± 0.18^{a} | 7.99 ± 5.01^{a} | 11.28 ± 8.38 |
| L23220 | | | | |
| CLL | | | | |
| FMBL | 24.11 ± 0.21^{b} | 2.8 ± 2.05^{b} | 11.31 ± 1.33^{b} | 13.19 ± 8.35 |
| L23251 | | | | |
| FJX | | | | |

Note:
Different superscript letters indicate significant differences.

### Embodiment 3: Comparison of Characteristics of Chickpea Milk Fermented by Different Strains

### 1. Strain Activation and Seed Culture Preparation

Same as in Embodiment 2.

### 2. Preparation and Fermentation of Chickpea Milk

100 g of chickpeas free from disease, pests, and mechanical damage were weighed. The chickpeas were soaked at a bean-to-water ratio of 1:2 for 12 hours, then filtered and drained. Subsequently, hot water at 60° C. and 0.45% α-medium temperature amylase were added at a bean-to-water ratio of 1:6. The mixture was ground in a blender for 8 minutes and enzymatically hydrolyzed at 60° C. for 24 minutes. The chickpea homogenate was then boiled for 5 minutes to inactivate the enzyme. After cooling, the homogenate was filtered through a sterilized 200-mesh filter cloth to obtain chickpea milk. The prepared chickpea milk was inoculated with the aforementioned seed culture at an inoculum size of 2% and fermented at 37° C. for 12 hours to obtain Lactiplantibacillus plantarum FMBL L23251 FJX fermented chickpea milk.

### 3. Antioxidant Capacity

### (1) DPPH Radical Scavenging Capacity

The procedure is the same as in Embodiment 2, with the sample replaced by chickpea milk.

### (2) ABTS Radical Scavenging Capacity

The procedure is the same as in Embodiment 2, with the sample replaced by chickpea milk.

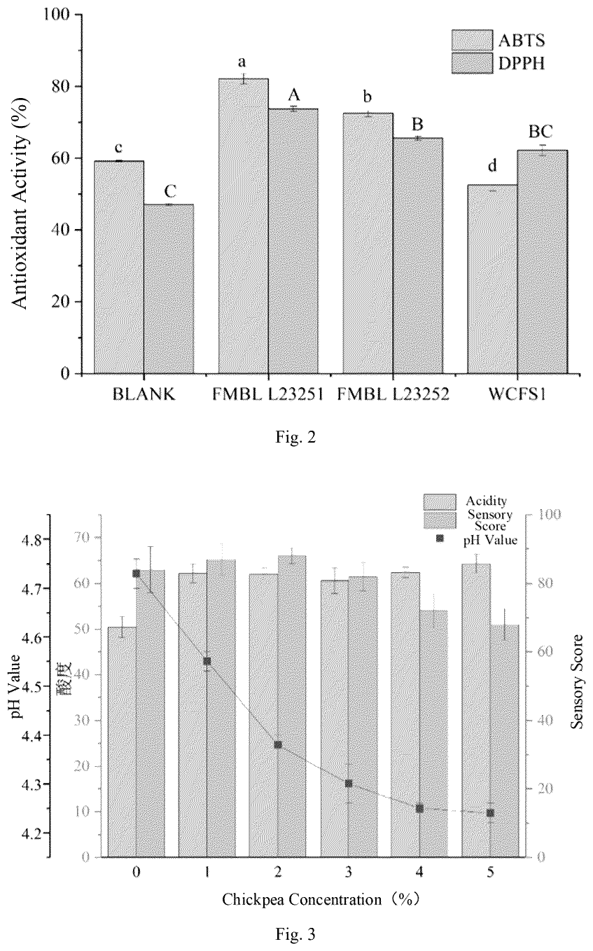

The results of the antioxidant activity of fermented chickpea milk are shown in FIG. 2. Compared with the levels before fermentation, the ABTS radical scavenging rate of the chickpea milk fermented by Lactiplantibacillus plantarum FMBL L23251 FJX increased substantially, with the ABTS scavenging rate increasing by 22.92% (59.18% before fermentation, 82.10% after fermentation). The ABTS scavenging rate of chickpea milk fermented by Lactiplantibacillus plantarum FMBL L23252 FJX increased by 13.33%. The DPPH scavenging rates of the chickpea milk fermented by the three strains were all higher than those before fermentation. Among them, Lactiplantibacillus plantarum FMBL L23251 FJX exhibited the highest DPPH scavenging rate, which was 26.73% higher than before fermentation (46.99% before fermentation, 73.72% after fermentation). In summary, the chickpea milk fermented by Lactiplantibacillus plantarum FMBL L23251 FJX possessed the strongest antioxidant capacity.

### 4. Determination of Short-Chain Fatty Acid Content

One milliliter of chickpea milk was centrifuged at 4° C. and 10000 rpm for 10 minutes. The supernatant was collected and passed through a 0.22 μm aqueous filter membrane to obtain the test sample.

Standard solution preparation: Ten milligrams each of acetic acid, propionic acid, butyric acid, isobutyric acid, valeric acid, isovaleric acid, and hexanoic acid standards were accurately weighed. Distilled water was added to bring the volume to the mark in a 10 mL brown volumetric flask, resulting in a mass concentration of 1 mg/mL for each standard.

Temperature program: The temperature was held at 50° C. for 3 min, increased to 114° C. at a rate of 6° C./min, held for 1 min, then increased to 160° C. at 6° C./min, finally increased to 220° C. at 30° C./min, and held for 10 min. Carrier gas: N2 flow rate was set at 3 mL/min, H2 flow rate at 47 mL/min, and air flow rate at 400 mL/min. Injection volume: 1 μL; Split ratio: 3:1; Injector temperature: 220° C.; Detector temperature: 240° C. Chromatographic column: DB-Wax.

The short-chain fatty acid content of chickpea milk fermented by the three strains is shown in Table 10. The short-chain fatty acid production capacity of Lactiplantibacillus plantarum FMBL L23251 FJX performed the best among all strains. The contents of all seven short-chain fatty acids increased significantly after fermentation. Specifically, the acetic acid content increased by 1.31 times compared to before fermentation; propionic acid content increased by 1.98 times; isobutyric acid content increased by 1.97 times; butyric acid content increased by 1.81 times; isovaleric acid content increased by 6.71 times; valeric acid content increased by 3.77 times; hexanoic acid content increased by 1.87 times compared to before fermentation.

TABLE 10
Short-Chain Fatty Acid Content of Fermented Chickpea Milk

| | Content (mg/L) | | | | | | |
|---|---|---|---|---|---|---|---|
| | Acetic | Propionic | Isobutyric | Butyric | Isovaleric | Valeric | Hexanoic |
| Strain | Acid | Acid | Acid | acid | Acid | acid | Acid |
| BLANK | 1423.88^{a} | 44.71^{c} | 23.23^{b} | 26.05^{a} | 30.0^{a} | 29.95^{a} | 33.83^{a} |
| FMBL | 1857.42^{c} | 88.97^{d} | 44.08^{c} | 44.91^{b} | 195.65^{c} | 111.96^{c} | 62.70^{b} |
| L23251 | | | | | | | |
| FJX | | | | | | | |
| FMBL | 1414.57^{a} | 30.82^{b} | 11.70^{a} | 27.20^{a} | 167.75^{b} | 71.68^{b} | 27.20^{a} |
| L23252 | | | | | | | |
| FJX | | | | | | | |
| WCFS1 | 1562.29^{b} | 17.76^{a} | 26.60^{b} | 57.10^{c} | 33.05^{a} | 29.21^{a} | 83.81^{c} |

Note:
Different superscript letters indicate significant differences between groups.

### 5. Determination of B Vitamin Content

Five grams of sample (accurately weighed to 0.01 g) were weighed into a 100 mL Erlenmeyer flask. The sample was dissolved with 25.0 mL of a 0.1% formic acid solution and extracted by ultrasonication for 20 minutes. Then, 2 mL of a 20% zinc acetate solution were added and mixed by vortexing. The mixture was transferred to a 50 mL volumetric flask and brought to volume with ultrapure water. The solution was centrifuged at 10000 rpm for 10 minutes. The supernatant was collected and passed through a 0.22 μm aqueous filter membrane, ready for instrumental analysis. Standard solutions using VB1, VB3, and VB6 as standards, respectively, were prepared for the quantitative analysis of B vitamins in the samples.

Chromatographic conditions: Waters ACQUITY PREMIER HSS T3 column (100 mm×2.1 mm, 1.7 μm); Flow rate: 0.3 mL/min; Injection volume: 1 μL; Column oven temperature: 30° C. The mobile phase consisted of 0.1% formic acid in water and acetonitrile, using a gradient elution program as detailed in Table 11 below.

TABLE 11
Gradient Elution Program

| | Flow Rate | 0.1% Formic Acid | |
|---|---|---|---|
| Time (min) | (mL/min) | in Water (%) | Acetonitrile (%) |
| 0 | 0.3 | 98 | 2 |
| 0.5 | 0.3 | 98 | 2 |
| 2.0 | 0.3 | 2 | 98 |
| 3.0 | 0.3 | 2 | 98 |
| 3.2 | 0.3 | 98 | 2 |
| 6.0 | 0.3 | 86 | 14 |

The results are shown in Table 12. Lactiplantibacillus plantarum WCFS1 significantly increased the VB1 content, whereas Lactiplantibacillus plantarum FMBL L23251 FJX and FMBL L23252 FJX significantly decreased the VB1 content in the fermented chickpea milk. However, the decrease in VB1 content in the chickpea milk fermented by Lactiplantibacillus plantarum FMBL L23251 FJX was significantly less than the decrease caused by FMBL L23252 FJX. The VB3 and VB6 contents in the fermented chickpea milk increased significantly. The VB3 and VB6 contents in the chickpea milk fermented by Lactiplantibacillus plantarum FMBL L23251 FJX were 1.90 times and 1.58 times the respective pre-fermentation contents, which were significantly higher than the levels achieved with Lactiplantibacillus plantarum FMBL L23252 FJX and WCFS1.

TABLE 12
Vitamin Content Determination

| | BLANK | FMBL L23251 | FMBL L23252 | WCFS1 |
|---|---|---|---|---|
| Sample | Content (mg/L) | | | |
| VB₁ | 468.75^{b} | 418.75^{c} | 347.91^{d} | 562.91^{a} |
| VB₃ | 271.67^{d} | 515^{a} | 475.83^{b} | 412.08^{c} |
| VB₆ | 93.75^{d} | 141.25^{a} | 106.25^{c} | 122.917^{b} |

Note:
Different superscript letters indicate significant differences between groups.

6. Determination of the Degradation Capacity of Lactiplantibacillus plantarum FMBL L23251 FJX on Beany Flavor

Five grams of soybean milk were taken. One gram of sodium chloride (NaCl) and 2 μL of a 0.1 mg/mL solution of 2-methyl-3-heptanone (as an internal standard) were added. The mixture was placed in a 20 mL headspace vial. The cap was tightly crimped. The vial was equilibrated at 50° C. for 20 minutes, after which a divinylbenzene/carboxen/polydimethylsiloxane (DVB/CAR/PDMS) extraction fiber was inserted and exposed for extraction and adsorption for 30 minutes.

Chromatographic conditions: Agilent HP-innowax column (30 m×0.25 μm); Carrier gas: Helium (He); Flow rate: 1.5 mL/min; Split ratio: 10:1. Temperature program: The temperature was held at 35° C. for 3 min, increased to 210° C. at a rate of 6° C./min, held for 10 min, then increased to 240° C. at a rate of 30° C./min, and held for 5 min. Mass spectrometry conditions: Electron impact (EI) ion source; Electron energy: 70 electronvolts (eV); Ion source temperature: 230° C.; Mass scan range: m/z 33-350 atomic mass units (amu).

The beany flavor substances in chickpea milk are the most critical factor for its low consumer acceptance. The beany flavor is primarily formed by a mixture of small molecular substances, including aldehydes (such as hexanal), alcohols (such as 1-hexanol), ketones (such as 2-butanone), and furans (such as 2-pentylfuran), which collectively create the characteristic off-odor of legumes, typically described as stinky, fishy, bitter, grassy, and astringent. Changes in the flavor compounds in chickpea milk before and after fermentation were determined, and the results are shown in Table 13. A total of 32 flavor compounds were identified in the non-fermented group and the fermented chickpea milk, including 6 organic acids, 5 alcohols, 12 aldehydes, 5 ketones, and 3 furans, with significant differences in the contents of these flavor compounds among the different groups. The main volatile compounds in chickpea milk before fermentation were primarily aldehydes, alcohols, and furans; these compounds are the main sources of unfavorable flavors in chickpeas, such as astringency and beany flavor. After fermentation by Lactiplantibacillus plantarum FMBL L23251 FJX and Lactiplantibacillus plantarum FMBL L23252 FJX, the contents of these compounds in the chickpea milk were significantly reduced. However, the degradation rate of beany flavor-related compounds by Lactiplantibacillus plantarum FMBL L23251 FJX was significantly higher than that by Lactiplantibacillus plantarum FMBL L23252 FJX. In contrast, the contents of most beany flavor-related compounds significantly increased in the chickpea milk fermented by Lactiplantibacillus plantarum WCFS1. Fermentation by Lactiplantibacillus plantarum FMBL L23251 FJX reduced the total content of furans in chickpea milk by over 98%, reduced the total aldehyde content by more than 83%, and reduced the total ketone content by nearly 70%. The degradation rates for compounds including 2-pentylfuran, nonenal, heptenal, nonadienal, benzaldehyde, 1-pentanol, and acetone by Lactiplantibacillus plantarum FMBL L23251 FJX exceeded those by Lactiplantibacillus plantarum FMBL L23252 FJX by more than 50%.

TABLE 13
Flavor Compounds in Fermented Chickpea Milk

| | BLANK | FMBL L23251 | FMBL L23252 | WCFS1 |
|---|---|---|---|---|
| Sample | Content (mg/L) | | | |
| 2-Ethylfuran | 2.44 ± 0.06 | nd | nd | 2.93 ± 0.01 |
| 2-Butylfuran | 2.77 ± 0.08 | nd | nd | nd |
| 2-Pentylfuran | 146.2 ± 2.69 | 4.4 ± 0.20 | 108.16 ± 10.5 | 38.50 ± 0.42 |
| 2,3-Butanedione | nd | 1.34 ± 0.000 | 4.71 ± 0.13 | 0.50 ± 0.03 |
| Acetoin | nd | 2.43 ± 0.03 | 4.52 ± 0.15 | 0.31 ± 0.08 |
| Pentanal | 4.31 ± 0.33 | 2.22 ± 0.10 | nd | 1.64 ± 0.41 |
| Hexanal | 80.39 ± 2.12 | 7.11 ± 0.0008 | 7.51 ± 0.09 | 19.87 ± 0.48 |
| Heptanal | 3.58 ± 0.14 | nd | nd | nd |
| Heptenal | 9.84 ± 0.28 | 1.51 ± 0.024 | 11.76 ± 1.04 | 9.83 ± 0.28 |
| Octenal | 11.76 ± 0.40 | 2.8 ± 0.02 | 8.79 ± 0.88 | nd |
| Octanal | 4.71 ± 0.09 | nd | nd | 5.73 ± 0.16 |
| Nonanal | 28.52 ± 0.37 | 1.49 ± 0.005 | nd | 0.96 ± 0.10 |
| Nonenal | 4.33 ± 0.000 | nd | 2.31 ± 0.22 | nd |
| Decanal | 4.09 ± 0.05 | 2.37 ± 0.27 | 5.68 ± 0.10 | nd |
| Nonadienal | 2.74 ± 0.01 | nd | 1.98 ± 0.27 | 0.74 ± 0.02 |
| Decadienal | 7.5 ± 0.38 | nd | 5.16 ± 0.77 | nd |
| Benzaldehyde | 11.62 ± 1.62 | 3.76 ± 0.0004 | 11.45 ± 0.29 | 4.79 ± 0.20 |
| 1-Pentanol | 12.56 ± 1.2 | 8.57 ± 0.08 | 16.78 ± 0.79 | 0.78 ± 0.08 |
| 1-Hexanol | nd | nd | 111.38 ± 1.01 | 55.66 ± 5.35 |
| 1-Heptanol | nd | 1.81 ± 0.08 | 9.47 ± 0.20 | 3.04 ± 0.13 |
| 1-Nonanol | nd | nd | 33.33 ± 0.61 | 5.59 ± 0.28 |
| 3-Octanol | 10.17 ± 0.56 | 1.32 ± 0.03 | 3.51 ± 0.31 | 1.48 ± 0.10 |
| Formic acid | 6.86 ± 0.11 | 9.51 ± 0.02 | 9.38 ± 0.10 | 4.07 ± 0.36 |
| Acetic acid | nd | 22.41 ± 1.32 | 19.56 ± 1.36 | 2.02 ± 0.01 |
| Valeric acid | nd | 1.22 ± 0.0001 | 1.24 ± 0.10 | 0.40 ± 0.01 |
| Hexanoic acid | 2.82 ± 0.20 | 125.2 ± 5.31 | 119.89 ± 1.32 | 37.74 ± 3.0 |
| Octanoic acid | nd | 5.25 ± 0.47 | 12.14 ± 0.98 | 1.25 ± 0.21 |
| Butyric acid | 4.96 ± 0.17 | 2.94 ± 0.10 | 11.31 ± 1.0 | 4.07 ± 0.36 |
| Acetone | 4.71 ± 0.28 | 2.08 ± 0.02 | 4.47 ± 0.19 | 3.49 ± 0.56 |
| 2-Heptanone | 6.58 ± 0.29 | 3.51 ± 0.07 | 6.89 ± 0.35 | 8.83 ± 0.81 |
| 3-Octen-2-one | 2.74 ± 0.56 | 4.16 ± 0.41 | 7.46 ± 0.35 | 2.51 ± 0.24 |
| 3-Nonen-2-one | 3.05 ± 0.17 | nd | 10.33 ± 0.88 | 0.32 ± 0.03 |

### 4. Determination of DPP-IV Inhibitory Activity

Into a 96-well microplate, 25 μL of glycine-p-nitroanilide (0.2 mM) and 25 μL of fermented soybean milk were added and pre-incubated at 37° C. for 10 minutes. Subsequently, 50 μL of DPP-IV (0.01 U/mL) was added and incubated at 37° C. for 60 minutes. The reaction was then terminated by adding 100 μL of sodium acetate buffer (1 M, pH 4.0). The absorbance of the sample was measured at 405 nm. In the reaction system, a PBS solution (0.1 mol/L, pH 6.8) was used as a blank control for both the DPP-IV solution and the test sample.

$$DPP - IV inhibition rate = [ 1 - ( A - B ) / ( C - D ) ] * 100 \%$$

Where: A represents the measured absorbance value for the well containing both the DPP-IV solution and the test sample. B represents the measured absorbance value for the well containing the test sample but no DPP-IV solution. C represents the measured absorbance value for the well containing the DPP-IV solution but no test sample. D represents the measured absorbance value for the well containing neither the DPP-IV solution nor the test sample.

TABLE 14
DPP-IV Inhibition Rate of Chickpea Milk Fermented by Strains

| | DPP-IV |
|---|---|
| | Inhibition |
| Group | Rate (%) |
| Lactiplantibacillus plantarum FMBL L23251 FJX | 63.81^{a} |
| Lactiplantibacillus plantarum WCFS1 | 40.42^{b} |
| Non-fermented Bean Liquid | 22.41^{c} |

Note:
Different superscript letters (^{a}, ^{b}, ^{c}) indicate significant differences (P < 0.05).

The results are shown in Table 14. The DPP-IV inhibition rate of the chickpea milk fermented by Lactiplantibacillus plantarum FMBL L23251 FJX was 63.81%, which was 1.85 times the DPP-IV inhibition rate of the non-fermented chickpea milk. The DPP-IV inhibition rate of the chickpea milk fermented by Lactiplantibacillus plantarum WCFS1 reached 40.42%. This indicates that Lactiplantibacillus plantarum FMBL L23251 FJX has substantial application potential in lowering blood sugar and improving diabetes, and the strain can be used for the preparation of products for lowering blood sugar and for diabetes.

### Embodiment 4: Process Optimization for Chickpea Yogurt Fermented by Lactiplantibacillus plantarum FMBL L23251 FJX

### 1. Strain Activation

Lactiplantibacillus plantarum FMBL L23251 FJX was deposited with the CCTCC on Jun. 26, 2023, under the accession number CCTCC NO: M 20231100.

Primary starter culture strains: Lactobacillus delbrueckii subsp. bulgaricus and Streptococcus thermophilus were purchased from Chr. Hansen A/S (Denmark). After activation on MRS agar plates, single colonies were picked and inoculated into MRS liquid medium. The strains were subcultured twice consecutively at 37° C., each time for 24 hours, with an inoculum size of 2%. The resulting fermentation broth was centrifuged at 10000 rpm for 10 minutes. The bacterial cells were washed twice with sterile physiological saline and then resuspended. The bacterial suspension concentration was adjusted to 1.0×108 CFU/mL for subsequent use.

### 2. Preparation of Chickpea Yogurt

(1) Chickpeas free from disease, pests, and mechanical damage were taken. The chickpeas were soaked at a bean-to-water ratio of 1:2 for 12 hours, then filtered and drained. The chickpeas were dried at 40-60° C. until dry or freeze-dried to a constant weight. The dried chickpeas were pulverized using an ultrafine grinder and then passed through a 200-mesh sieve to obtain chickpea powder.

(2) The chickpea powder obtained in step (1) was mixed uniformly with fresh milk at a specified ratio. The mixture was supplemented with 8% sucrose and 0.20%-0.30% of a composite mixture comprising esterified pectin, sodium carboxymethyl cellulose, and xanthan gum. After thorough stirring until complete dissolution and homogenization, the mixture was sterilized at 95° C. for 10 minutes and then cooled to room temperature for subsequent use.

(3) Bacterial suspensions of Lactobacillus delbrueckii subsp. bulgaricus, Streptococcus thermophilus, and Lactiplantibacillus plantarum FMBL L23251 FJX were inoculated at specified proportions and mixed uniformly. The mixture was fermented at a constant temperature of 40° C. until coagulation occurred. The coagulated product was then aged at 4° C. for 16 hours to obtain the fermented chickpea yogurt.

### 3. Determination of pH Value and Acidity of Chickpea Yogurt

Ten milliliters of chickpea yogurt were taken. The pH value of the fermented milk was measured using a pH meter. The acidity of the chickpea yogurt was determined by referring to the Chinese National Standard GB 5009.239-2016 “Determination of Acidity in Foods.”

### 4. Sensory Evaluation of Chickpea Yogurt

Thirty milliliters of the fermented product were taken. The sensory evaluation was conducted by referring to the standard “RHB 104-2020 Fermented Milk Sensory Evaluation Rules” issued by the China Dairy Industry Association.

5. Biomass Measurement of Lactiplantibacillus plantarum FMBL L23251 FJX in Chickpea Yogurt

Genomic DNA of microorganisms in the fermented milk was extracted using a kit. The viable cell count of Lactiplantibacillus plantarum FMBL L23251 FJX in the fermented milk was determined using the quantitative polymerase chain reaction (qPCR) method. Absolute quantification was performed according to the reaction system and reaction conditions of the standard curve (Table 15). The obtained cycle threshold (Ct) values were substituted into the corresponding standard curve. The viable cell count of Lactiplantibacillus plantarum FMBL L23251 FJX in the yogurt sample was calculated by combining the sampling amount and the dilution factor of the fermented milk sample DNA. The results were expressed as log 10 CFU/mL.

Preparation of the standard curve: The concentration of the extracted DNA was tested using a microvolume nucleic acid quantifier to obtain a known concentration. Then, a 10-fold serial dilution was performed, diluting up to 10-6. The nucleic acid dilutions at each concentration gradient were used as templates. The standard amplification curve was plotted according to the reaction system in Table 15.

Reaction conditions: Pre-denaturation at 95° C. for 30 seconds; followed by 40 cycles of denaturation at 95° C. for 10 seconds, annealing at 55° C. for 30 seconds, and extension at 72° C. for 25 seconds.

Table 15 qPCR Primers and Reaction System

| Template | Genomic DNA |
|---|---|
| Primers | Lplantarum-F: 5′-ATTCATAGTCTAGTTGGAGGT-3′ |
| | Lplantarum-R: 5′-CCTGAACTGAGAGAATTTGA-3′ |
| Reaction | Total volume 20 μL: SYBR Green 10 μL, forward primer (F) 0.2 μL, |
| System | reverse primer (R) 0.2 μL, ddH2O 8.1 μL, DNA template 1.5 μL |

### 6. Effect of Chickpea Addition Amount on Yogurt Quality

According to the chickpea yogurt preparation process, chickpea powder was uniformly mixed with fresh milk at ratios of 1% to 5%. The mixture was supplemented with 8% sucrose and 0.20% to 0.30% of a composite mixture comprising esterified pectin, sodium carboxymethyl cellulose, and xanthan gum. After thorough stirring until completely dissolved and homogenized, the mixture was sterilized at 95° C. for 10 minutes. Bacterial suspensions of Lactobacillus delbrueckii subsp. bulgaricus, Streptococcus thermophilus, and Lactiplantibacillus plantarum FMBL L23251 FJX were inoculated at a ratio of 1:1:1 and mixed uniformly. The inoculated mixture was fermented at a constant temperature of 40° C. until coagulation occurred, followed by aging at 4° C. for 16 hours. The effects of the chickpea addition amount on the quality of the fermented milk were evaluated by determining the acidity, pH, viable cell count of Lactiplantibacillus plantarum FMBL L23251 FJX, and conducting sensory analysis.

Adding chickpeas can provide plant-derived proteins, polysaccharides, and other nutrients for Lactiplantibacillus plantarum, thereby promoting the growth and metabolism of Lactiplantibacillus plantarum FMBL L23251 FJX in the fermented milk. The effects of different chickpea ratios on the quality of the fermented milk and the biomass of Lactiplantibacillus plantarum FMBL L23251 FJX are shown in FIG. 3 and Table 16. The pH of the fermented milk decreased rapidly with increasing chickpea concentration, but an excessively low pH adversely affects the taste of the yogurt. Within the range of 2% chickpea concentration, the biomass of Lactiplantibacillus plantarum FMBL L23251 FJX and the acidity showed an increasing trend with increasing chickpea concentration. When the chickpea concentration was ≥2%, the biomass of Lactiplantibacillus plantarum FMBL L23251 FJX and the acidity basically stabilized, with no significant increasing trend.

TABLE 16
Viable Lactic Acid Bacteria Counts at
Different Chickpea Concentrations

| Chickpea Addition | Lactiplantibacillus plantarum |
|---|---|
| Amount | log₁₀ (CFU/mL) |
| 0% | 7.62 ± 0.02^{a} |
| 1% | 7.90 ± 0.01^{b} |
| 2% | 8.11 ± 0.02^{c} |
| 3% | 8.13 ± 0.01^{c} |
| 4% | 8.14 ± 0.03^{c} |
| 5% | 8.15 ± 0.02^{c} |

Sensory evaluation found that when the chickpea concentration was ≤2%, the sensory score of the fermented milk was positively correlated with the chickpea concentration. This is related to the increased thickness imparted by chickpeas and the plant-based aroma and taste they give to the fermented milk. However, when the chickpea concentration exceeded 2%, the chickpea yogurt gradually exhibited excessive sourness, beany flavor, and astringency with increasing chickpea concentration. Therefore, the subsequent experiments were conducted using the optimal chickpea addition amount of 2% that provided the best taste.

7. Effect of Lactiplantibacillus plantarum FMBL L23251 FJX Inoculation Ratio on Yogurt Quality

According to the chickpea yogurt preparation process, chickpea powder was uniformly mixed with fresh milk at a ratio of 2%. The mixture was supplemented with 8% sucrose and 0.20%-0.30% of a composite mixture comprising esterified pectin, sodium carboxymethyl cellulose, and xanthan gum. After thorough stirring until completely dissolved and homogenized, the mixture was sterilized at 95° C. for 10 minutes. Bacterial suspensions of Lactobacillus delbrueckii subsp. bulgaricus, Streptococcus thermophilus, and Lactiplantibacillus plantarum FMBL L23251 FJX were inoculated at ratios of 1:1:1, 1:1:2, 1:1:3, 1:1:4, and 1:1:5, respectively. The inoculated mixtures were stirred uniformly and fermented at a constant temperature of 40° C. until coagulation occurred, followed by aging at 4° C. for 16 hours. The effects of the Lactiplantibacillus plantarum FMBL L23251 FJX inoculation ratio on the quality of the fermented milk were evaluated by determining the acidity, pH, and conducting sensory analysis.

The effects of different inoculation ratios of the auxiliary starter culture Lactiplantibacillus plantarum FMBL L23251 FJX on the quality of the fermented milk are shown in Table 17. As the inoculation ratio of Lactiplantibacillus plantarum FMBL L23251 FJX increased, the acidity of the fermented milk increased rapidly, the pH value gradually decreased, and the yogurt fermentation coagulation time continuously shortened. When the inoculation ratio was ≤1:1:2, the changes in acidity and pH of the yogurt were relatively small, and the sensory score of the yogurt increased with the increase in the inoculation ratio. When the inoculation ratio was ≥1:1:3, the magnitude of pH change in the yogurt also increased, and the sensory score of the yogurt gradually decreased significantly with the further increase in the inoculation ratio. This is because excessively high acidity and excessively low pH adversely affect the sensory properties of the yogurt. When the inoculation ratio was greater than 1:1:4, a large amount of whey was expelled after coagulation, and excessively rapid coagulation was not conducive to the formation of flavor compounds.

Based on a comprehensive evaluation of the pH, acidity, and sensory score of the fermented yogurt, the yogurt fermented with Lactobacillus delbrueckii subsp. bulgaricus, Streptococcus thermophilus, and Lactiplantibacillus plantarum FMBL L23251 FJX at a ratio of 1:1:2 was optimal.

TABLE 17
pH, Acidity, and Sensory Scores of Fermented
Milk with Different Inoculation Ratios

| Inoculation Ratio | pH | Acidity (°T) | Sensory Score |
|---|---|---|---|
| 1:1:1 | 4.55^{a} | 70^{a} | 75^{b} |
| 1:1:2 | 4.45^{a} | 78^{b} | 82^{a} |
| 1:1:3 | 4.27^{b} | 84^{c} | 78^{ab} |
| 1:1:4 | 4.19 ^{b} | 89^{c} | 68^{c} |
| 1:1:5 | 4.10 ^{bc} | 96^{d} | 60^{d} |

### Embodiment 8: Stability and Flavor of Chickpea Yogurt Fermented by Lactiplantibacillus plantarum FMBL L23251 FJX

### 1. Experimental Groups

The preparation process of the fermented milk was the same as in Embodiment 4.

The experiment was divided into a total of 4 groups, comprising 3 control groups (M-2, M-3, D-2) and one experimental group (D-3). Details are provided in Table 18.

TABLE 18
Experimental Group Design

| | Raw Milk | |
|---|---|---|
| Group | Composition | Strains |
| M-2 | Fresh Milk | Lactobacillus delbrueckii subsp. bulgaricus, |
| | | Streptococcus thermophilus (1:1) |
| M-3 | Fresh Milk | Lactobacillus delbrueckii subsp. bulgaricus, |
| | | Streptococcus thermophilus, |
| | | Lactiplantibacillus plantarum (1:1:2) |
| D-2 | 2% Chickpea + | Lactobacillus delbrueckii subsp. bulgaricus, |
| | Fresh Milk, | Streptococcus thermophilus (1:1) |
| | Other Auxiliary | |
| | Ingredients | |
| D-3 | 2% Chickpea, | Lactobacillus delbrueckii subsp. bulgaricus, |
| | Fresh Milk, | Streptococcus thermophilus, |
| | Other Auxiliary | Lactiplantibacillus plantarum (1:1:2) |
| | Ingredients | |

### 2. Antioxidant Capacity of Chickpea Yogurt

The operating procedure was the same as in Embodiment 2 described above.

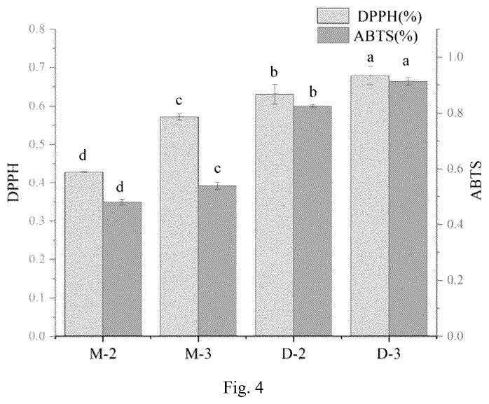

The antioxidant capacities of the four groups of fermented milk are shown in FIG. 4. Among them, group M-2 had the lowest antioxidant capacity, with DPPH and ABTS scavenging rates of 42.79% and 47.95%, respectively. Group D-3 had the highest antioxidant capacity, with DPPH and ABTS scavenging rates of 67.86% and 91.27%, respectively. Comparing M-2 with M-3, and D-2 with D-3, it can be concluded that adding Lactiplantibacillus plantarum FMBL L23251 FJX as an auxiliary starter culture significantly enhances the antioxidant capacity of the yogurt. Comparing M-2 with D-2, and M-3 with D-3, it can be concluded that the combination of Lactiplantibacillus plantarum FMBL L23251 FJX and chickpeas can further significantly enhance the antioxidant capacity of the yogurt.

### 3. Physical Properties of Chickpea Yogurt

### 3.1 Water Holding Capacity of Chickpea Yogurt

A 50 mL centrifuge tube was selected and weighed; the mass was recorded as m1. Approximately 10 g of yogurt was placed into the centrifuge tube, and the mass of the centrifuge tube and the yogurt was recorded as m2. The centrifuge tube was centrifuged at room temperature at 5000 rpm for 30 minutes. The supernatant was poured off, and the centrifuge tube was inverted for 10 minutes and then weighed; the mass was recorded as m3. The water holding capacity (WHC) of the yogurt was calculated using the following formula:

$$WHC = ( m 3 - m 1 ) / ( m 2 - m 1 )$$

The WHC of the different groups are shown in Table 19. Overall, the groups containing chickpea milk (D-2, D-3) exhibited higher WHC than the groups without chickpea (M-2, M-3). The groups containing Lactiplantibacillus plantarum as an auxiliary starter culture (M-3, D-3) exhibited higher WHC than the groups without Lactiplantibacillus plantarum.

TABLE 19
Water Holding Capacity of Fermented Milk

| Group | Raw Milk Composition |
|---|---|
| M-2 | 49.94% ± 0.37^{d} |
| M-3 | 51.34% ± 0.33^{c} |
| D-2 | 55.31% ± 1.62^{b} |
| D-3 | 59.15% ± 1.14^{a} |

3.2 Texture of Chickpea Yogurt

Texture profile analysis (TPA) was performed on yogurt samples after 12 hours of aging. The test was conducted using an A/BE probe with a diameter of 30 mm in a 250 mL glass container (diameter 86 mm, height 80 mm). The pre-test speed, test speed, and post-test speed were set at 1.0 mm/s, 1.0 mm/s, and 5.0 mm/s, respectively. The penetration distance was 20 mm, and the surface trigger force was 10 g.

The texture characteristics of the fermented milk from different groups are shown in Table 20. The hardness, viscosity, chewiness, and springiness of the fermented milk from the four groups showed an increasing trend. These results are consistent with the WHC measurements, demonstrating that group D-3 had the most compact casein three-dimensional network gel structure, while group M-2 had the least compact structure. This outcome resulted from the combined action of chickpea milk and Lactiplantibacillus plantarum FMBL L23251 FJX.

TABLE 20
Texture Characteristics of Fermented Milk

| Group | Hardness (g) | Viscosity (g · s) | Chewiness | Springiness |
|---|---|---|---|---|
| M-2 | 128.09 ± 7.10^{d} | 127.23 ± 3.24^{d} | 52.24 ± 3.99^{d} | 0.46 ± 0.03^{d} |
| M-3 | 140.44 ± 5.43^{c} | 100.57 ± 6.89^{c} | 53.67 ± 2.75^{dc} | 0.47 ± 0.01^{c} |
| D-2 | 150.23 ± 3.73^{b} | 153.83 ± 4.14^{ba} | 60.076 ± 1.36^{b} | 0.50 ± 0.02^{b} |
| D-3 | 194.27 ± 7.41^{a} | 156.563 ± 4.03^{a} | 65.746 ± 3.58^{a} | 0.53 ± 0.02^{a} |

### 4. Determination of Volatile Flavor Compounds

The operating procedure was the same as in Embodiment 3 described above.

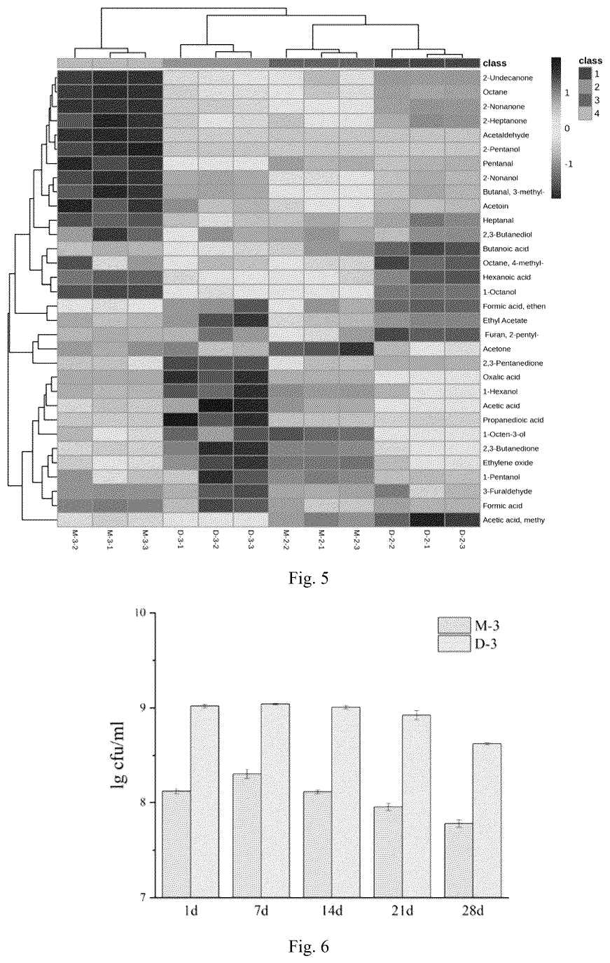

The detection results of volatile flavor compounds in the four types of fermented milk are shown in FIG. 5. A total of 32 flavor compounds were identified, including 7 alcohols, 6 aldehydes, 6 ketones, 8 acids, 2 esters, 2 alkanes, and 1 furan. Overall, the differences in volatile flavor compounds between the four groups were significant. The main flavor compounds in group D-3 were formic acid, acetic acid, oxalic acid, malonic acid, butyric acid, hexanoic acid, ethyl acetate, 1-hexanol, 1-octanol, 2,3-butanediol, 2,3-butanedione, and 2-heptanone. These flavor compounds can impart a unique fermented aroma, cheesy flavor, and creamy note to the chickpea milk. Furthermore, the contents of most of these compounds in group D-3, such as hexanoic acid, butyric acid, ethyl acetate, acetic acid, and 1-octanol, were significantly higher than those in the control groups. In contrast, the contents of compounds related to beany flavor in group D-2, such as 2-pentylfuran, acetone, 1-pentanol, and heptanal, were significantly higher than those in groups D-3 and M-3. Most of these beany flavor-related compounds in group D-3 were degraded by Lactiplantibacillus plantarum FMBL L23251 FJX.

5. Changes in Viable Cell Count of Lactiplantibacillus plantarum FMBL L23251 FJX in Chickpea Yogurt During Storage

DNA was extracted from yogurt samples stored at 4° C. for 0, 7, 14, 21, and 28 days, respectively. The changes in the viable cell count of Lactiplantibacillus plantarum FMBL L23251 FJX in the prepared yogurt during the shelf life were detected using the qPCR method, following the operating procedure described in Embodiment 3 above.

The changes in the viable cell count of Lactiplantibacillus plantarum FMBL L23251 FJX in the fermented yogurt during storage are shown in FIG. 6. The viable cell count of Lactiplantibacillus plantarum FMBL L23251 FJX in the prepared chickpea yogurt was significantly higher by approximately one order of magnitude compared to the yogurt without added chickpea after fermentation ended, reaching 1.2×109 CFU/mL. During the first seven days of storage, the viable cell count of Lactiplantibacillus plantarum FMBL L23251 FJX in the yogurt showed a slow increasing trend. After seven days, the viable cell count of Lactiplantibacillus plantarum FMBL L23251 FJX in the fermented milk began to gradually decrease. After 21 days of storage, although the viable cell count of Lactiplantibacillus plantarum FMBL L23251 FJX in the fermented chickpea yogurt decreased slightly, it still reached 7.9×108 CFU/mL, far exceeding the requirement specified in the Chinese National Standard “GB 19302-2010 National Food Safety Standard Fermented Milk”.

In summary, the present disclosure provides a Lactiplantibacillus plantarum strain FMBL L23251 FJX. The Lactiplantibacillus plantarum strain FMBL L23251 FJX was deposited with the CCTCC on Jun. 26, 2023, under the accession number CCTCC NO: M 20231100. The Lactiplantibacillus plantarum strain FMBL L23251 FJX possesses properties including antioxidant activity, acid tolerance, sensitivity to antibiotics, and substantial antibacterial activity. Fermentation of chickpeas using the strain demonstrates DPPH radical scavenging capacity, ABTS radical scavenging capacity, and DPP-IV inhibitory activity, produces short-chain fatty acids and B vitamins, and significantly reduces the beany flavor in legume products. Combining the strain with chickpea powder to prepare chickpea yogurt, while ensuring the viable cell count during storage, further enhances the antioxidant capacity of the yogurt and also promotes the release of volatile flavor compounds. The Lactiplantibacillus plantarum strain FMBL L23251 FJX has broad application prospects.

What is claimed is:

1. A Lactiplantibacillus plantarum strain FMBL L23251 FJX, deposited with the China Center for Type Culture Collection (CCTCC) under the accession number CCTCC NO: M 20231100.

2. The strain according to claim 1, wherein the strain is for use in the preparation of a bacterial agent or a fermentation broth.

3. The strain according to claim 2, wherein the bacterial agent or the fermentation broth has antioxidant, acid-tolerant, and/or antibacterial properties.

4. A use of the strain according to claim 1 in the manufacture of a food or a dietary supplement.

5. The use according to claim 4, wherein the food or the dietary supplement is yogurt or prebiotic yogurt.

6. The use according to claim 4, wherein the food or the dietary supplement is a legume product.

7. The use according to claim 6, wherein the legume product is prepared by fermenting a legume, wherein the legume is selected from the group consisting of chickpea, soybean, broad bean, pea, mung bean, mixed bean, pigeon pea, and sword bean, and combinations thereof.

8. The use according to claim 6, wherein the legume product is fermented bean milk or fermented bean yogurt.

9. The use according to claim 8, wherein the fermented bean milk or the fermented bean yogurt has reduced beany flavor.

10. The use according to claim 8, wherein the fermented bean milk has increased short-chain fatty acid content.

11. The use according to claim 8, wherein the fermented bean milk is capable of inhibiting dipeptidyl peptidase IV activity.

12. The use according to claim 8, wherein the fermented bean milk has a blood sugar-lowering effect.

13. The use according to claim 9, wherein the fermented bean yogurt is fermented chickpea yogurt.

14. A method of reducing beany flavor in a legume product, comprising using the legume product as a substrate and fermenting the substrate with the strain according to claim 1.

15. A fermented bean milk having reduced beany flavor, wherein the fermented bean milk is produced by the method according to claim 14.
